(19) United States
(12) Patent Application Publication
(10) Pub. No.: US 2026/0164356 A1
(43) Pub. Date: Jun. 11, 2026

(54) METHOD AND APPARATUS FOR DETERMINING SLEEP STATE OF TERMINAL DEVICE

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/126,770

(22) PCT Filed: Nov. 4, 2022
(86) PCT No.: PCT/CN2022/130099

§ 371 Date: May 2, 2025

(51) Int. Cl. H04W 52/02; H04W 72/044

(52) U.S. Cl. CPC H04W 52/0235; H04W 72/044

(57) ABSTRACT

The present disclosure relates to a method and apparatus for determining a sleep state of a terminal device. The method includes: a terminal device receiving a wake-up message; and the terminal device sending a wake-up response message, wherein the wake-up response message can be used for instructing a network device to determine a sleep state of the terminal device.

### CROSS-REFERENCE TO RELATED APPLICATION

The present application is a National Stage of International Application No. PCT/CN2022/130099, filed on Nov. 4, 2022, the entire disclosure of which is incorporated herein by reference for all purposes.

### TECHNICAL FIELD

The present disclosure relates to the field of communication technology, and specifically, to a method and an apparatus for determining the sleep state of a terminal device.

### BACKGROUND

In a wireless communication system, in order to reduce the power consumption of terminal devices, 3GPP (3rd Generation Partnership Project) introduced power-saving signals, such as wake-up signaling (WUS). The WUS signal is a low power detection signal. If the terminal device detects the WUS signal, it can monitor the physical downlink control channel (PDCCH). If the terminal device fails to detect the WUS, it can skip the monitoring of the PDCCH, so that it can be in a sleep state of low power consumption and reduce the power consumption of the terminal device.

In the related art, after the terminal device detects the WUS signal, it can be awakened from the sleep state and monitor the PDCCH, while the network device cannot determine the sleep state of the terminal device, which will affect the reliability of communication between the terminal device and the network device.

### SUMMARY

The present disclosure provides a method and an apparatus for determining the sleep state of a terminal device.

According to the first aspect of embodiments of the present disclosure, a method for determining a sleep state of a terminal device is provided, the method is performed by the terminal device, and the method includes:
receiving a wake-up message;
sending a wake-up response message, wherein the wake-up response message is used to indicate a network device to determine the sleep state of the terminal device.

According to the second aspect of embodiments of the present disclosure, a method for determining a sleep state of a terminal device is provided, the method is performed by a network device, and the method includes:
sending a wake-up message;
receiving a wake-up response message;
determining the sleep state of the terminal device according to the wake-up response message.

According to the third aspect of embodiments of the present disclosure, a terminal device is provided, which includes:
a receiving module, configured to receive a wake-up message;
a sending module, configured to send a wake-up response message, wherein the wake-up response message is used to indicate a network device to determine a sleep state of a terminal device.

According to the fourth aspect of embodiments of the present disclosure, a network device is provided, which includes:
a sending module, configured to send a wake-up message;
a receiving module, configured to receive a wake-up response message;
a processing module, configured to determine a sleep state of a terminal device according to the wake-up response message.

According to the fifth aspect of embodiments of the present disclosure, an apparatus for determining a sleep state of a terminal device is provided, which includes:
a processor;
a memory configured to store instructions executable by the processor;
wherein, the processor is configured to execute steps of the method for determining a sleep state of a terminal device provided by the first aspect of the present disclosure.

According to the sixth aspect of embodiments of the present disclosure, an apparatus for determining a sleep state of a terminal device is provided, which includes:
a processor,
a memory configured to store instructions executable by the processor;
wherein, the processor is configured to execute steps of the method for determining a sleep state of a terminal device provided by the second aspect of the present disclosure.

According to the seventh aspect of embodiments of the present disclosure, a non-transitory computer-readable storage medium is provided, having computer program instructions stored thereon, wherein when the computer program instructions are executed by the processor, the processor is caused to implement steps of the method for determining a sleep state of a terminal device provided by the first aspect of the present disclosure.

According to the eighth aspect of embodiments of the present disclosure, a non-transitory computer-readable storage medium is provided, having computer program instructions stored thereon, wherein when the computer program instructions are executed by the processor, the processor is caused to implement steps of the method for determining a sleep state of a terminal device provided by the second aspect of the present disclosure.

According to the ninth aspect of embodiments of the present disclosure, a communication system is provided, which includes:
a terminal device, configured to execute the method for determining a sleep state of a terminal device provided by the first aspect of the present disclosure;
a network device, configured to execute the method for determining a sleep state of a terminal device provided by the second aspect of the present disclosure.

It should be understood that the above general description and the detailed description below are only exemplary and explanatory, and cannot limit the present disclosure.

### BRIEF DESCRIPTION OF THE DRAWINGS

The drawings herein are incorporated into the specification and constitute a part of the specification, illustrate embodiments consistent with the present disclosure, and are used to explain the principles of the present disclosure together with the specification.

FIG. 1 is a schematic diagram of a communication system according to an example embodiment.

FIG. 2 is a flowchart of a method for determining the sleep state of a terminal device according to an example embodiment.

FIG. 3 is a flowchart of a method for determining the sleep state of a terminal device according to an example embodiment.

FIG. 4 is a flowchart of a method for determining the sleep state of a terminal device according to an example embodiment.

FIG. 5 is a flowchart of a method for determining the sleep state of a terminal device according to an example embodiment.

FIG. 6 is a flowchart of a method for determining the sleep state of a terminal device according to an example embodiment.

FIG. 7 is a flowchart of a method for determining the sleep state of a terminal device according to an example embodiment.

FIG. 8 is a flowchart of a method for determining the sleep state of a terminal device according to an example embodiment.

FIG. 9 is a flowchart of a method for determining the sleep state of a terminal device according to an example embodiment.

FIG. 10 is a block diagram of a terminal device according to an example embodiment.

FIG. 11 is a block diagram of a terminal device according to an example embodiment.

FIG. 12 is a block diagram of a network device according to an example embodiment.

FIG. 13 is a block diagram of an apparatus for determining the sleep state of a terminal device according to an example embodiment.

### DETAILED DESCRIPTION

The example embodiments will be described in detail here, and examples thereof are shown in the accompanying drawings. When the following description refers to the drawings, unless otherwise indicated, the same numbers in different drawings represent the same or similar elements. The implementations described in the following example embodiments do not represent all implementations consistent with the present disclosure. Instead, they are only examples of apparatuses and methods consistent with some aspects of the present disclosure as detailed in the attached claims.

It should be noted that all actions of obtaining signals, information or data in the present disclosure are carried out under the premise of complying with the corresponding data protection laws and policies of the country of location and with the authorization given by the owner of the corresponding apparatus.

In the description of the present disclosure, the used terms, such as “first”, “second”, etc., are used to distinguish similar objects, and do not have to be understood as a specific order or sequence. In addition, in the description of the reference drawings, the same reference numeral in different drawings represents the same element unless otherwise stated.

In the description of the present disclosure, unless otherwise specified, “a plurality of” means two or more than two, and other quantifiers are similar; “at least one item”, “one or more items” or similar expressions refer to any combination of these items, including any combination of single items or plural items. For example, at least one item can represent any number. For another example, one or more items of a, b and c can represent: a, b, c, a-b, a-c, b-c, or a-b-c, where a, b, c can be single or plural. “And/or” is a kind of association relationship that describes the associated objects, indicating that there can be three relationships. For example, A and/or B can represent: A exists alone, A and B exist at the same time, and B exists alone, where A and B can be singular or plural.

Although the operations or steps are described in a specific order in the drawings in the embodiments of the present disclosure, it should not be understood as requiring the operations or steps to be performed in the specific order shown or in a serial order, or requiring the execution of all the operations or steps shown to obtain the desired results. In the embodiments of the present disclosure, the operations or steps can be performed in series; the operations or steps can also be performed in parallel; or a part of the operations or steps can be performed.

The implementation environment of the embodiments of the present disclosure is first introduced below.

The technical solutions of the embodiments of the present disclosure can be applied to various communication systems. The communication system may include one or more of a 4G (4th Generation) communication system, a 5G (5 th Generation) communication system, and other future wireless communication systems (such as 6G). The communication system may also include one or more of a Public Land Mobile Network (PLMN) network, a Device-to-Device (D2D) communication system, a Machine-to-Machine (M2M) communication system, an Internet of Things (IoT) communication system, a Vehicle-to-Everything (V2X) communication system, or other communication systems.

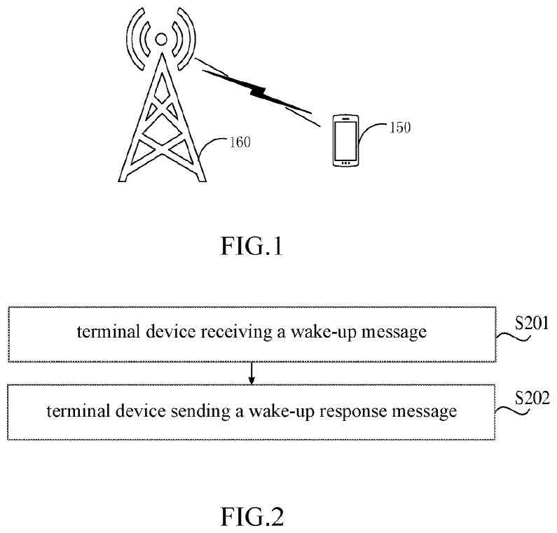

FIG. 1 is a schematic diagram of a communication system according to an example embodiment. As shown in FIG. 1, the communication system may include a terminal device 150 and a network device 160. The communication system may be used to support 4G network access technology, such as Long Term Evolution (LTE) access technology, or 5G network access technology, such as New Radio Access Technology (New RAT), or other future wireless communication technologies. It should be noted that, in the communication system, the number of network devices and terminal devices can be one or more. The number of network devices and terminal devices in the communication system shown in FIG. 1 is only an adaptive example, and the present disclosure does not limit this.

The network device in FIG. 1 can be used to support terminal access. For example, the network device can be an evolutional Node B (eNB or eNodeB) in LTE. The network device can also be the next Generation Node B (gNB or gNodeB) in a 5G network. The network device can also be an NG Radio Access Network (NG-RAN) device in a 5G network. The network device can also be a base station, a Broadband Network Gateway (BNG), an aggregation switch or a non-3GPP (3rd Generation Partnership Project) access device in a future evolved public land mobile network (PLMN), etc. Optionally, the network device in the embodiments of the present disclosure may include various forms of base stations, such as macro base stations, micro base stations (also known as small stations), relay stations, access points, 5G base stations or future base stations, satellites, Transmitting and Receiving Points (TRP), Transmitting Points (TP), mobile switching centers, and Device-to-Device (D2D), Machine-to-Machine (M2M), Internet of Things (IoT), Vehicle-to-Everything (V2X) or other devices that undertake the function of base stations in communication, etc., which are not specifically limited in the embodiment of the present disclosure. For convenience of description, in all embodiments of the present disclosure, the apparatuses that provide wireless communication functions for terminal devices are collectively referred to as network devices or base stations.

The terminal device in FIG. 1 can be an electronic device that provides voice or data connectivity. For example, the terminal device can also be called User Equipment (UE), Subscriber Unit, Mobile Station, Station, Terminal, etc. For example, the terminal device may include a smart phone, a smart wearable device, a smart speaker, a smart tablet, a wireless modem, a Wireless Local Loop (WLL) station, a PDA (Personal Digital Assistant), CPE (Customer Premise Equipment), etc. With the development of wireless communication technology, devices that can access a communication system, communicate with network devices of a communication system, communicate with other objects through a communication system, or two or more devices that can communicate directly with each other can all be terminal devices in the embodiments of the present disclosure; for example, terminals and cars in smart transportation, household devices in smart homes, power meter reading instruments in smart grid, voltage monitoring instruments, environmental monitoring instruments, video monitoring instruments in smart security networks, cash registers, etc. In the embodiments of the present disclosure, the terminal device can communicate with the network device. A plurality of terminal devices can also communicate with each other. The terminal device can be statically fixed or mobile, and the present disclosure does not limit this.

In some embodiments, the terminal device in FIG. 1 can be a terminal device that supports the power saving function. For example, when the terminal device does not send or receive data, the primary radio can be in a sleep state under different degrees. In one implementation, the sleep state of the terminal device can include one or more of ultra-deep sleep, deep sleep, light sleep, and micro sleep. The time required for the primary radio of the terminal device to wake up from different sleep states is different. In addition, due to the different hardware or software capabilities of the terminal itself, times for different terminal devices to be awakened from the same sleep state are also different.

It should be noted that the terminal device can be in an awakened state after being awakened, and the awakened state of the terminal device can be considered as a different state relative to the sleep state, or as a special form of the sleep state, which is not limited in this disclosure.

It should also be noted that the above-mentioned primary radio may include a primary transceiver and/or a primary receiver, the primary transceiver may be one or more, and the primary receiver may also be one or more.

The terminal device in FIG. 1 can support receiving low power WUS signals, and the network device can support sending WUS signals.

In some embodiments, the terminal device may receive the WUS signal using a primary radio (primary transceiver and/or primary receiver).

In other embodiments, the terminal device may use a separate receiver to receive the WUS signal, and use the primary transceiver to receive downlink signals and send uplink signals, or use the primary receiver to receive downlink signals, and the primary receiver and/or the primary transceiver may be referred to as the primary radio of the terminal device. If the terminal device receives a WUS signal indicating that the terminal device to be awakened, the terminal device will turn on the primary transceiver for receiving and processing downlink/uplink information, or turn on the primary receiver for receiving and processing downlink information. If the WUS is not received, or the WUS indicates not to wake up the terminal, the terminal device will maintain the sleep state of the primary transceiver and/or the primary receiver, wherein the WUS signal can be applied to any state of the terminal device, such as the RRC (Radio Resource Control) connection state or RRC idle state. In the RRC connection state and RRC idle state, in order to keep the terminal device closed for a long time, the receiver for receiving the WUS can complete the synchronization function, for example, synchronization can be achieved by monitoring the SSB (Synchronization Signal Block), or the WUS itself also has the function of achieving synchronization.

FIG. 2 is a flowchart of a method for determining the sleep state of a terminal device according to an example embodiment. The method can be performed by a terminal device in the above communication system. As shown in FIG. 2, the method may include following steps.
S201, the terminal device receives a wake-up message.

In some embodiments, the wake-up message may be a message sent by a network device. For example, the wake-up message may be a message or signal for indicating the terminal device to change the sleep state. For example, the wake-up message may be a Wake-Up Signaling or a Low Power Wake-Up Signaling.
S202, the terminal device sends a wake-up response message.

The wake-up response message may be used to indicate the network device to determine the sleep state of the terminal device.

In some embodiments, the wake-up response message may also be referred to as a Wake-Up Response Signaling or a Low Power Wake-Up Response Signaling.

In some embodiments, the wake-up response message may be used to indicate to the network device to determine that the terminal device is awakened from the sleep state.

For example, after the terminal device wakes up the primary radio in response to receiving the wake-up message, the terminal device may send the wake-up response message to indicate to the network device that the primary radio of the terminal device is awakened and communication can be performed.

In some other embodiments, the wake-up response message may be used to indicate the network device to determine the change of the sleep state of the terminal device.

For example, the terminal device may change the sleep state from deep sleep to light sleep in response to receiving the wake-up message, and send the wake-up response message to indicate to the network device the change of the sleep state of the terminal device.

In one implementation, the sleep state may be the sleep state of the primary radio of the terminal device, and the primary radio may include a primary transceiver and/or a primary receiver.

In another implementation, the sleep state may also be the state of a communication component of the terminal device, and the communication component may include a primary radio and/or a wireless modem, etc.

By using the above method, the terminal device sends a wake-up response message in response to receiving the wake-up message, and the wake-up response message may be used to indicate the network device to determine the sleep state of the terminal device. In this way, the terminal device can notify the network device of the sleep state through the wake-up response message, such that the network device can determine the sleep state of the terminal device and improve the reliability of communication between the terminal device and the network device.

In some embodiments, the above-mentioned wake-up response message may include a terminal identifier corresponding to the terminal device. The terminal identifier may also be called UEID (User Equipment ID), and the UEID may include any one or more of IMEI (International Mobile Equipment Identity), IMSI (International Mobile Subscriber Identity), TMSI (Temporary Mobile Subscriber Identity), RNTI (Radio Network Temporary Identity), GUTI (Globally Unique Temporary UE Identity) and other identifiers assigned by the network device to the terminal device.

In other embodiments, the above-mentioned wake-up response message may include a terminal group identifier of the terminal device group to which the terminal device belongs. The terminal group identifier may be used to indicate a specific terminal device group, and the terminal device group may include a plurality of terminal devices performing multicast or broadcast services.

In other embodiments, the above-mentioned wake-up response message may include a terminal identifier and a terminal group identifier.

In this way, through the terminal identifier and/or terminal group identifier, it can indicate the network device to determine the terminal device and/or terminal device group whose sleep state has changed.

FIG. 3 is a flowchart of a method for determining the sleep state of a terminal device according to an example embodiment. As shown in FIG. 3, the method may include following steps.
S301, the terminal device receives a wake-up message.
S302, the terminal device sends a wake-up response message through the first resource.

The wake-up response message can be used to indicate the network device to determine the sleep state of the terminal device.

In some embodiments, the first resource is a resource corresponding to the terminal device, and different terminal devices can correspond to different first resources. In this way, the first resource can be used to indicate the network device to determine the terminal device according to the first resource.

In other embodiments, the first resource is a resource corresponding to the terminal device group to which the terminal device belongs, and different terminal device groups can correspond to different first resources. The terminal devices in the same terminal device group can use the same resource, such that the first resource can be used to indicate the network device to determine the terminal device group to which the terminal device belongs according to the first resource.

In some embodiments, the first resource may include a first frequency domain resource. For example, the first frequency domain resource may be one or more of frequency domain resources such as RE (Resource Element), REG (Resource Element Group), RB (Resource Block) or RBG (Resource Block Group).

The terminal device may send the above-mentioned wake-up response message through the first frequency domain resource corresponding to the terminal device.

In other embodiments, the first resource may include a first time domain resource. For example, the first time domain resource may include a symbol or a time slot. For example, the first time domain resource may include a specified time slot or a specified symbol, or the first time domain resource may include a specified symbol in each time slot.

The terminal device may send the above-mentioned wake-up response message through the first time domain resource corresponding to the terminal device.

In some other embodiments, the first resource may include a first time-frequency resource, and the first time-frequency resource may be a resource jointly determined by the time domain and the frequency domain. For example, within a time window, the entire bandwidth resource may be divided into M×N parts, each of which corresponds to a pending time-frequency resource, and the first time-frequency resource may be one or more resources in the pending time-frequency resource. For example, the first time-frequency resource may be a specified RB resource within a specified time slot, or the first time-frequency resource may be a specified RE resource within a specified symbol.

The terminal device may send the above-mentioned wake-up response message through the first time-frequency resource corresponding to the terminal device.

In some other embodiments, the first resource may include a first beam resource. The terminal device may send the above-mentioned wake-up response message through the first beam resource corresponding to the terminal device.

It should be noted that, the first resource may include any one or more of the above-mentioned first frequency domain resource, first time domain resource, first time-frequency resource and first beam resource. For example, it may be the first time-frequency resource on the first beam resource. For another example, the first resource may be a combination of the first frequency domain resource, the first time domain resource and the first beam resource.

In some embodiments of the present disclosure, the above-mentioned first resource may be specified by the network device, or may be agreed upon according to the protocol.

In some embodiments, the terminal device may determine the first resource according to the first resource indication parameter in the first message in response to receiving the first message.

The first message may be a message sent by the network device. The first message may include at least one of the Downlink Control Information (DCI), Medium Access Control Control Element (MAC CE), radio resource control RRC message and wake-up message.

In some embodiments, the above-mentioned first message is one, and the terminal device may determine the first resource through the above-mentioned first message. For example, the terminal device may obtain the first resource indication parameter from the wake-up message, and determine the first resource according to the first resource indication parameter.

In some other embodiments, the first message may be plural, and the terminal device may receive the plurality of first messages respectively, and jointly determine the first resource according to the received plurality of first messages. For example: the first message may include message 1 and message 2, and the terminal device may first obtain one or more candidate resources and the candidate identifier corresponding to each candidate resource according to the received message 1, and then determine the target identifier according to the received message 2, and determine the first resource from one or more candidate resources according to the target identifier. For example, the candidate resource whose candidate identifier is equal to the target identifier may be used as the first resource.

The message 1 may be any one of an RRC message, a DCI, a MAC CE, and a wake-up message, and the message 2 may also be any one of an RRC message, a DCI, a MAC CE, and a wake-up message. The message 1 and the message 2 may be messages of the same type or messages of different types.

For example, the message 1 may be an RRC message, and the message 2 may be a DCI, a MAC CE, or a wake-up message.

For another example, the message 1 may be an RRC message or a MAC CE, and the message 2 may be a DCI or a wake-up message.

In this way, the terminal device may flexibly determine the first resource through the first message.

In some embodiments, the first message may include a system message sent by a network device.

In some embodiments, the terminal device may determine the first resource corresponding to the terminal device by receiving a system message.

In other embodiments, the terminal device may determine the first resource corresponding to the terminal device group to which the terminal device belongs by receiving a system message.

In other embodiments, the terminal device may determine the first resource based on the resource receiving the wake-up message.

In one implementation, the terminal device may use the frequency domain resource receiving the wake-up message as the first resource, and send a wake-up response message through the first resource.

In another implementation, the terminal device may determine the candidate time domain resource based on the time domain resource receiving the wake-up message. For example, the Nth symbol after receiving the wake-up message may be used as the candidate time domain resource, and the uplink frequency domain resource corresponding to the downlink frequency domain resource receiving the wake-up message may be used as the candidate frequency domain resource, and the first resource may be determined through the candidate time domain resource and the candidate frequency domain resource.

In this way, the terminal device may determine the first resource through the above manner.

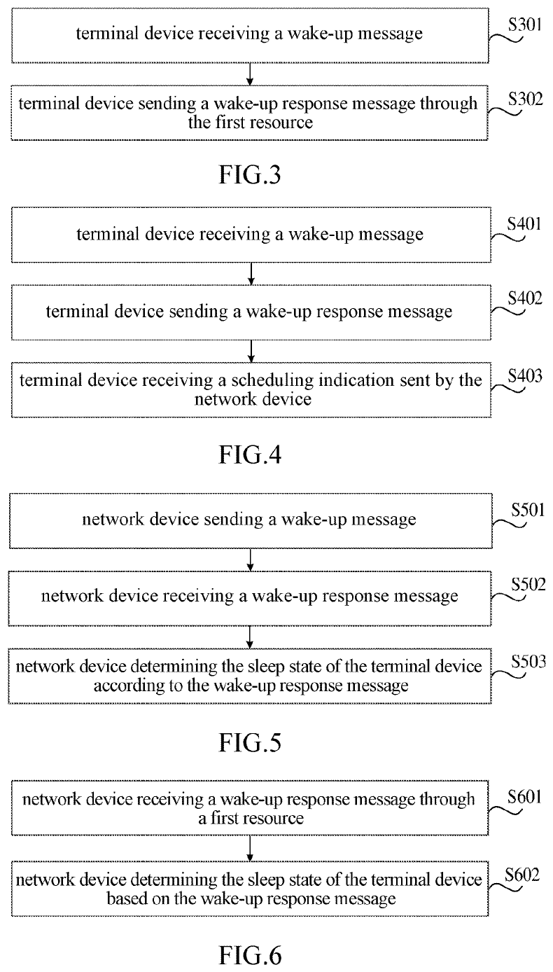

FIG. 4 is a flowchart of a method for determining the sleep state of a terminal device according to an example embodiment. As shown in FIG. 4, the method may include following steps.
S401, the terminal device receives a wake-up message.
S402, the terminal device sends a wake-up response message.
S403, the terminal device receives a scheduling indication sent by the network device.

The scheduling indication is used to indicate the terminal device to transmit data or signaling. For example, the scheduling indication may be a DCI or MAC CE sent by the network device.

In some embodiments, the terminal device may receive the scheduling indication through the primary radio.

In some embodiments, the terminal device may receive the scheduling indication sent by the network device through the primary radio after a preset time of sending the wake-up response message.

The terminal device may transmit data or signaling according to the scheduling indication, for example, it may receive data, send data, receive signaling or send signaling according to the scheduling indication.

The above-mentioned preset time may be a time expressed in a universal time unit, such as N milliseconds, and N may be any positive integer, such as 4 milliseconds or 8 milliseconds. The preset time may also be a time expressed in any one of symbol, time slot, frame, and sub-frame. For example, the preset time may be M symbols, and the preset time may also be M time slots, and M may be any positive integer.

In some embodiments, the preset time may be a time pre-agreed by the protocol, and the terminal device and the network device may determine the preset time according to the protocol agreement.

In some other embodiments, the preset time may also be a time pre-configured by the network device, and the network device may notify the terminal device through the above-mentioned wake-up message, system message or other RRC messages.

In some other embodiments, the preset time may be a time pre-configured by the terminal device, and the terminal device may notify the network device of the preset time through a wake-up response message, such that the network device schedules the terminal device according to the preset time.

In this way, the terminal device may send a wake-up response message and communicate with the network device according to the scheduling indication, thereby improving the communication reliability.

FIG. 5 is a flowchart of a method for determining the sleep state of a terminal device according to an example embodiment. The method may be executed by a network device in the above-mentioned communication system. As shown in FIG. 5, the method may include following steps.
S501, the network device sends a wake-up message.

In some embodiments, the wake-up message may be a message or signal for indicating the terminal device to change the sleep state. For example, the wake-up message may be a wake-up signaling or a low power wake-up signaling.
S502, the network device receives a wake-up response message.
S503, the network device determines the sleep state of the terminal device according to the wake-up response message.

In some embodiments, the wake-up response message may also be referred to as a wake-up response signaling or a low power wake-up response signaling. The terminal device may send a wake-up response message in response to receiving the wake-up message.

In some embodiments, the network device may determine that the terminal device is awakened from the sleep state according to the wake-up response message.

In other embodiments, the network device may determine the change of the sleep state of the terminal device according to the wake-up response message. For example, the sleep state changes from deep sleep to light sleep.

By using the above method, the network device determines the sleep state of the terminal device according to the wake-up response message, thereby improving the reliability of communication between the network device and the terminal device.

In some embodiments, the above wake-up response message may include a terminal identifier corresponding to the terminal device. The terminal identifier may also be referred to as a UEID. The network device may determine the terminal device according to the terminal identifier.

In other embodiments, the above wake-up response message may include a terminal group identifier of the terminal device group to which the terminal device belongs. The terminal group identifier can be used to indicate a specific terminal device group, and the terminal device group may include a plurality of terminal devices that perform multicast or broadcast services. The network device can determine the terminal device group based on the terminal group identifier.

In some other embodiments, the above-mentioned wake-up response message may include a terminal identifier and a terminal group identifier.

In some implementations, the network device can determine the sleep state of the terminal device based on the terminal identifier and/or the terminal group identifier.

In other implementations, the network device can wake up a plurality of terminal devices through a wake-up message, and then determine the terminal device whose sleep state has changed (for example, awakened) based on the terminal identifier and/or the terminal group identifier in the wake-up response message.

FIG. 6 is a flowchart of a method for determining the sleep state of a terminal device according to an example embodiment. As shown in FIG. 6, the method may include following steps.
S601, the network device receives a wake-up response message through a first resource.
S602, the network device determines the sleep state of the terminal device based on the wake-up response message.

In some embodiments, the first resource is a resource corresponding to the terminal device, and different terminal devices may correspond to different first resources. In this way, the network device can determine the terminal device based on the first resource.

In some other embodiments, the first resource is a resource corresponding to the terminal device group to which the terminal device belongs. Different terminal device groups may correspond to different first resources, and terminal devices in the same terminal device group may correspond to the same first resource. In this way, the network device can determine the terminal device group to which the terminal device belongs based on the first resource.

In some embodiments, the first resource may include a first frequency domain resource. For example, the first frequency domain resource may be a frequency domain resource such as RE, REG, RB or RBG.

The terminal device may send the above-mentioned wake-up response message through the first frequency domain resource corresponding to the terminal device.

In some other embodiments, the first resource may include a first time domain resource. For example, the first time domain resource may include a symbol or a time slot. For example, the first time domain resource may include a specified time slot or a specified symbol, or the first time domain resource may include a specified symbol in each time slot.

The terminal device may send the above-mentioned wake-up response message through the first time domain resource corresponding to the terminal device.

In some other embodiments, the first resource may include a first time-frequency resource. For example, within a time window, the entire bandwidth resource can be divided into M×N parts, each of which corresponds to a pending time-frequency resource, and the first time-frequency resource can be one or more resources in the pending time-frequency resource. For example, the first time-frequency resource can be a designated RB resource in a designated time slot, or the first time-frequency resource can be a designated RE resource in a designated symbol.

The terminal device can send the above-mentioned wake-up response message through the first time-frequency resource corresponding to the terminal device.

In some other embodiments, the first resource can include a first beam resource. The terminal device can send the above-mentioned wake-up response message through the first beam resource corresponding to the terminal device.

It should be noted that the first resource can include any one or more of the above-mentioned first frequency domain resource, first time domain resource, first time-frequency resource and first beam resource. For example, it can be a first time-frequency resource on a first beam resource. For another example, the first resource can be a combination of a first frequency domain resource, a first time domain resource and a first beam resource.

In some embodiments of the present disclosure, the above-mentioned first resource can be specified by a network device or according to a protocol agreement.

In some embodiments, the network device may send a first message to the terminal device, and the first message may include a first resource indication parameter, and the first resource indication parameter may be used to indicate the terminal device to determine the first resource.

The first message may include one or more of downlink control information DCI, media access control control unit MAC CE, and radio resource control RRC message.

In some embodiments, the above-mentioned first message may include a system message. For example, the network device may send the first resource indication parameter through a system message.

In other embodiments, the correspondence between the terminal device and the first resource may be pre-set, for example, it may be a resource correspondence agreed upon by the protocol.

In this way, the network device may determine the terminal device or the terminal device group according to the above-mentioned first resource.

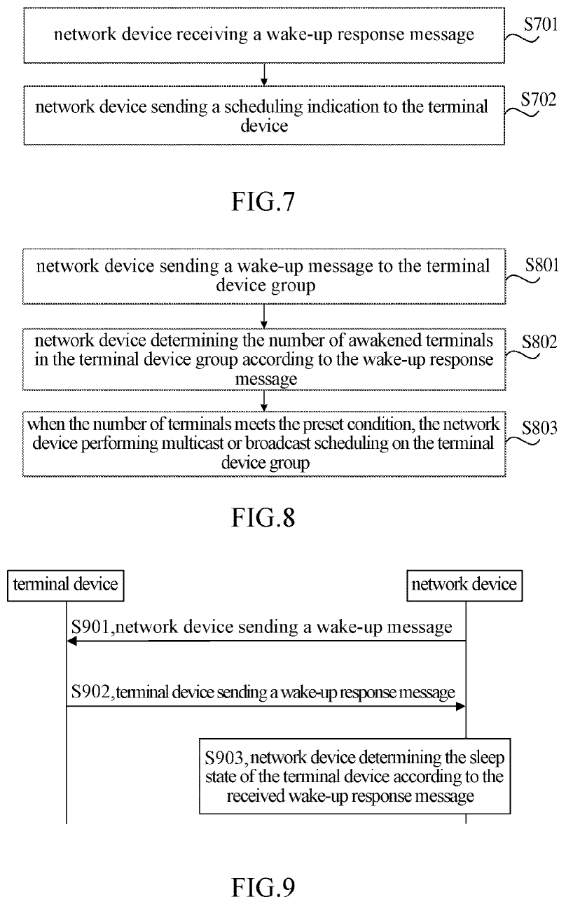

FIG. 7 is a flowchart of a method for determining the sleep state of a terminal device according to an example embodiment. As shown in FIG. 7, the method may include following steps.
S701, the network device receives a wake-up response message.
S702, the network device sends a scheduling indication to the terminal device.

In some embodiments, the network device may schedule the terminal device when receiving the wake-up response message, for example, send a scheduling indication to the terminal device.

In other embodiments, the network device may schedule the terminal device after a preset time of receiving the wake-up response message. For example, the network device may start a preset timer (the timer duration may be a preset time) after receiving the wake-up response message. When the preset timer expires, the network device may schedule the terminal device, for example, send a scheduling indication to the terminal device.

The preset time may be a time expressed in a universal time unit, such as N milliseconds, and N may be any positive integer, such as 4 milliseconds or 8 milliseconds. The preset time may also be a time expressed in any one of symbol, time slot, frame, and sub-frame. For example, the preset time may be M symbols, and the preset time may also be M slots, and M may be any positive integer.

In some embodiments, the preset time may be a time pre-agreed by the protocol, and the terminal device and the network device may determine the preset time according to the protocol agreement.

In some other embodiments, the preset time may also be a time pre-configured by the network device, and the network device may notify the terminal device through the above-mentioned wake-up message, system message or other RRC messages.

In some other embodiments, the preset time may be a time pre-configured by the terminal device, and the terminal device may notify the network device of the preset time through the wake-up response message.

In this way, the network device schedules the terminal device in response to receiving the wake-up response message, which can improve the reliability of communication between the network device and the terminal device.

FIG. 8 is a flowchart of a method for determining the sleep state of a terminal device according to an example embodiment. As shown in FIG. 8, the method may include following steps.
S801, the network device sends a wake-up message to the terminal device group.
S802, the network device determines the number of awakened terminals in the terminal device group according to the wake-up response message.

For example, the network device may use the number of received wake-up response messages as the number of awakened terminals.
S803, when the number of terminals meets the preset condition, the network device performs multicast or broadcast scheduling on the terminal device group.

For example, the preset condition may include that the number of terminals is greater than or equal to a preset threshold, and the preset threshold may be any preset value.

In some embodiments, the preset condition may be that the number of terminals is greater than or equal to a preset number threshold. The preset number threshold may be any preset value, such as 5 or 10.

In other embodiments, the preset condition may be that the ratio of the number of terminals to the total number of terminal devices in the terminal device group is greater than or equal to a preset ratio threshold. The preset ratio threshold may be any preset value between 0 and 1, such as 0.5 or 0.8.

In this way, the network device can wake up the terminal device group when performing multicast or broadcast service scheduling.

FIG. 9 is a flowchart of a method for determining the sleep state of a terminal device according to an example embodiment. As shown in FIG. 9, the method may include following steps.
S901, the network device sends a wake-up message.
S902, the terminal device sends a wake-up response message.

In some embodiments, the terminal device may send a wake-up response message to the network device in response to receiving the wake-up message sent by the network device.

In some embodiments, the terminal device may send a wake-up response message to the network device through a first resource in response to receiving the wake-up message.

S903, the network device determines the sleep state of the terminal device according to the received wake-up response message.

It should be noted that the specific implementation of the above steps can refer to the description in the aforementioned embodiments of the present disclosure, which will not be repeated here.

According to one or more embodiments of the present disclosure, a communication system as shown in FIG. 1 is provided. In the communication system as shown in FIG. 1, the network device 160 can be configured to send a wake-up message; and determine the sleep state of the terminal device according to the wake-up response message in response to receiving the wake-up response message. The terminal device 150 can be configured to send a wake-up response message in response to receiving the wake-up message.

It should be noted that the specific manner in which the network device and the terminal device perform the above operations can refer to the detailed description in the aforementioned embodiments of the present disclosure, which will not be elaborated here.

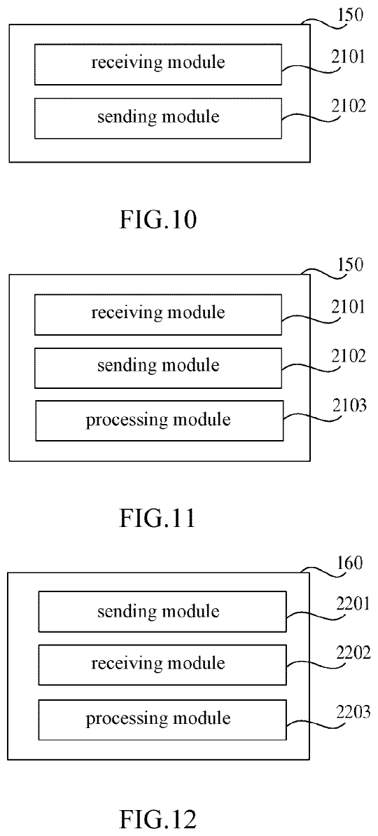

FIG. 10 is a block diagram of a terminal device 150 shown according to an example embodiment. As shown in FIG. 10, the terminal device 150 may include:
a receiving module 2101 configured to receive a wake-up message;
a sending module 2102 configured to send a wake-up response message, wherein the wake-up response message is used to indicate a network device to determine the sleep state of the terminal device.

In some embodiments, the wake-up response message includes a terminal identifier corresponding to the terminal device, and/or a group identifier of a terminal device group to which the terminal device belongs.

In some embodiments, the sending module 2102 is configured to send the wake-up response message through a first resource, wherein the first resource is a resource corresponding to the terminal device, or the first resource is a resource corresponding to a terminal device group to which the terminal device belongs.

In some embodiments, the first resource includes at least one of the following:
a first frequency domain resource;
a first time domain resource;
a first beam resource.

FIG. 11 is a block diagram of a terminal device 150 shown according to an example embodiment. As shown in FIG. 11, the terminal device 150 may also include:
a processing module 2103, configured to determine the first resource according to a first resource indication parameter in the first message in response to receiving a first message, and determining; or, determine the first resource according to a resource receiving the wake-up message.

In some embodiments, the first message includes at least one of the following:
downlink control information DCI;
a media access control control unit MAC CE;
an radio resource control RRC message.

In some embodiments, the receiving module 2101 is also configured to receive a scheduling indication sent by the network device through a primary radio, after a preset time of sending the wake-up response message, wherein the scheduling indication is used to indicate the terminal device to transmit data or signaling.

FIG. 12 is a block diagram of a network device 160 according to an example embodiment. As shown in FIG. 12, the network device 160 may include:
a sending module 2201, configured to send a wake-up message;
a receiving module 2202, configured to receive a wake-up response message;
a processing module 2203, configured to determine the sleep state of the terminal device according to the wake-up response message.

In some embodiments, the wake-up response message includes a terminal identifier corresponding to the terminal device, and/or a terminal group identifier of a terminal device group to which the terminal device belongs.

In some embodiments, the wake-up response message is a message received through a first resource; the receiving module 2202 is configured to determine the terminal device according to the first resource; or, determine a terminal device group to which the terminal device belongs according to the first resource.

In some embodiments, the first resource includes at least one of the following:
a first frequency domain resource;
a first time domain resource;
a first beam resource.

In some embodiments, the sending module 2201 is further configured to send a first message, wherein the first message includes a first resource indication parameter, the first resource indication parameter is used to indicate the terminal device to determine the first resource.

In some embodiments, the first message includes at least one of the following:
downlink control information DCI;
a media access control control unit MAC CE;
an radio resource control RRC message.

In some embodiments, the sending module 2201 is configured to send a scheduling indication to the terminal device after a preset time of receiving the wake-up response message, wherein the scheduling indication is used to indicate the terminal device to transmit data or signaling.

In some embodiments, the sending module 2201 is further configured to send the wake-up message to the terminal device group; determine a number of awakened terminals in the terminal device group according to the wake-up response message; perform multicast or broadcast scheduling on the terminal device group in a case that the number of terminals meets a preset condition.

Regarding the apparatus in the above embodiments, the specific manner in which each module performs the operation has been described in detail in the embodiments of the method, which will not be elaborated here.

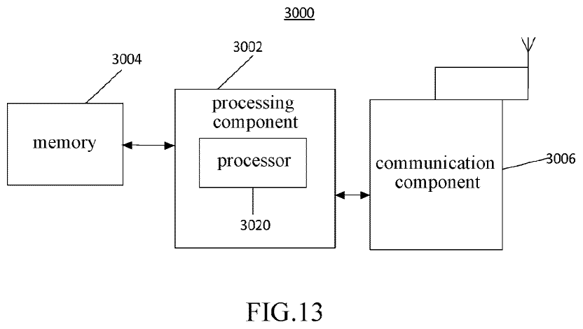

FIG. 13 is a block diagram of an apparatus for determining the sleep state of a terminal device according to an example embodiment. The apparatus 3000 for determining the sleep state of a terminal device may be a terminal device in the communication system shown in FIG. 1, or may be a network device in the communication system.

Referring to FIG. 13, the apparatus 3000 may include one or more of the following components: a processing component 3002, a memory 3004, and a communication component 3006.

The processing component 3002 may be used to control the overall operation of the apparatus 3000, such as operations associated with display, phone calls, data communications, camera operations, and recording operations. The processing component 3002 may include one or more processors 3020 to execute instructions to complete all or part of the steps of the above-mentioned method for determining the sleep state of a terminal device. In addition, the processing component 3002 may include one or more modules to facilitate interaction between the processing component 3002 and other components. For example, the processing component 3002 may include a multimedia module to facilitate interaction between the multimedia component and the processing component 3002.

The memory 3004 is configured to store various types of data to support operations in the apparatus 3000. Examples of such data include instructions for any application or method operating on the apparatus 3000, contact data, phone book data, messages, pictures, videos, etc. The memory 3004 may be implemented by any type of transitory or non-transitory storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The communication component 3006 is configured to facilitate wired or wireless communication between the apparatus 3000 and other devices. The apparatus 3000 may access a wireless network based on a communication standard, such as Wi-Fi, 2G, 3G, 4G, 5G, 6G, NB-IOT, eMTC, etc., or a combination thereof. In an example embodiment, the communication component 3006 receives a broadcast signal or broadcast-related information from an external broadcast management system via a broadcast channel. In an example embodiment, the communication component 3006 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, the apparatus 3000 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements, to perform the above-mentioned method for determining the sleep state of the terminal device.

The above-mentioned apparatus 3000 may be a standalone electronic device or a part of a standalone electronic device. For example, in one embodiment, the electronic device may be an integrated circuit (IC) or a chip, wherein the integrated circuit may be an IC or a collection of a plurality of ICs. The chip may include but is not limited to the following types: GPU (Graphics Processing Unit), CPU (Central Processing Unit), FPGA (Field Programmable Gate Array), DSP (Digital Signal Processor), ASIC (Application Specific Integrated Circuit), SOC (System on Chip), etc. The above-mentioned integrated circuit or chip may be used to execute executable instructions (or codes), to implement the above-mentioned method for determining the sleep state of the terminal device. The executable instructions may be stored in the integrated circuit or chip, or may be obtained from other apparatuses or devices, such as a processor, a memory, and an interface for communicating with other apparatuses included in the integrated circuit or chip. The executable instruction may be stored in the processor, and when the executable instruction is executed by the processor, the above method for determining the sleep state of the terminal device is implemented; or, the integrated circuit or chip may receive the executable instruction through the interface and transmit it to the processor for execution, to implement the above method for determining the sleep state of the terminal device.

In an example embodiment, the present disclosure also provides a computer-readable storage medium, on which computer program instructions are stored, and when the program instructions are executed by the processor, the steps of the method for determining the sleep state of the terminal device provided by the present disclosure are implemented. By way of example, the computer-readable storage medium may be a non-transitory computer-readable storage medium including instructions, for example, the above memory 3004 including instructions, and the above instructions may be executed by the processor 3020 of the apparatus 3000 to complete the above method for determining the sleep state of the terminal device. For example, the non-transitory computer-readable storage medium may be a ROM, a random access memory (RAM), a CD-ROM, a magnetic tape, a floppy disk, an optical data storage device, etc.

In another example embodiment, a computer program product is also provided, which includes a computer program that can be executed by a programmable apparatus, and the computer program has a code portion for executing the above-mentioned method for determining the sleep state of a terminal device when executed by the programmable apparatus.

After considering the specification and practicing the present disclosure, it will be easy for a person skilled in the art to think of other embodiments of the present disclosure. This application is intended to cover any variation, use or adaptive change of the present disclosure, which follows the general principles of the present disclosure and includes common knowledge or conventional technical means in the technical field that are not disclosed in the present disclosure. The description and embodiments are to be regarded as exemplary only, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

1. A method for determining a sleep state of a terminal device, performed by the terminal device, and the method comprising:
receiving a wake-up message;
sending a wake-up response message, wherein the wake-up response message is used to indicate a network device to determine the sleep state of the terminal device.

2. The method according to claim 1, wherein the wake-up response message comprises at least one of a terminal identifier corresponding to the terminal device, or a group identifier of a terminal device group to which the terminal device belongs.

3. The method according to claim 1, wherein sending the wake-up response message comprises:
sending the wake-up response message through a first resource, wherein the first resource is a resource corresponding to the terminal device, or the first resource is a resource corresponding to a terminal device group to which the terminal device belongs.

4. The method according to claim 3, wherein the first resource comprises at least one of the following:
a first frequency domain resource;
a first time domain resource;
a first beam resource.

5. The method according to claim 3, further comprising:
receiving a first message, and determining the first resource according to a first resource indication parameter in the first message; or, determining the first resource according to a resource receiving the wake-up message.

6. The method according to claim 5, wherein the first message comprises at least one of the following:
downlink control information (DCI);
a media access control control unit (MAC CE);
an radio resource control (RRC) message.

7. The method according to claim 1, further comprising:
receiving a scheduling indication sent by the network device through a primary radio, after a preset time of sending the wake-up response message, wherein the scheduling indication is used to indicate the terminal device to transmit data or signaling.

8. A method for determining a sleep state of a terminal device, performed by a network device, and the method comprising:
sending a wake-up message;
receiving a wake-up response message;
determining the sleep state of the terminal device according to the wake-up response message.

9. The method according to claim 8, wherein the wake-up response message comprises a terminal identifier corresponding to the terminal device, and/or a terminal group identifier of a terminal device group to which the terminal device belongs.

10. The method according to claim 8, wherein the wake-up response message is a message received through a first resource; determining the sleep state of the terminal device according to the wake-up response message comprises:
determining the terminal device according to the first resource; or,
determining a terminal device group to which the terminal device belongs according to the first resource.

11. The method according to claim 10, wherein the first resource comprises at least one of the following:
a first frequency domain resource;
a first time domain resource;
a first beam resource.

12. The method according to claim 10, further comprising:
sending a first message, wherein the first message comprises a first resource indication parameter, the first resource indication parameter is used to indicate the terminal device to determine the first resource.

13. The method according to claim 12, wherein the first message comprises at least one of the following:
downlink control information (DCI);
a media access control control unit (MAC CE);
an radio resource control (RRC) message.

14. The method according to claim 8, further comprising:
sending a scheduling indication to the terminal device after a preset time of receiving the wake-up response message, wherein the scheduling indication is used to indicate the terminal device to transmit data or signaling.

15. The method according to claim 8, wherein sending the wake-up message comprises:
sending the wake-up message to a terminal device group;
the method further comprising:
determining a number of awakened terminals in the terminal device group according to the wake-up response message;
performing multicast or broadcast scheduling on the terminal device group in a case that the number of terminals meets a preset condition.

16. (canceled)

17. (canceled)

18. An apparatus for determining a sleep state of a terminal device, comprising:
a processor;
a memory configured to store instructions executable by the processor;
wherein, the processor is configured to:
receive a wake-up message;
send a wake-up response message, wherein the wake-up response message is used to indicate a network device to determine the sleep state of the terminal device.

19. A non-transitory computer-readable storage medium, having computer program instructions stored thereon, wherein when the computer program instructions are executed by the processor, the processor is caused to implement steps of the method according to claim 1.

20. A communication system, comprising:
a terminal device, configured to execute the method according to claim 1; and
a network device, configured to execute the method according to claim 8.

21. An apparatus for determining a sleep state of a terminal device, comprising:
a processor;
a memory configured to store instructions executable by the processor;
wherein, the processor is configured to execute steps of the method for determining the sleep state of the terminal device according to claim 8.

22. A non-transitory computer-readable storage medium, having computer program instructions stored thereon, wherein when the computer program instructions are executed by the processor, the processor is caused to implement steps of the method for determining the sleep state of the terminal device according to claim 8.
